(19) United States
(12) Patent Application Publication
(10) Pub. No.: US 2015/0325220 A1
(43) Pub. Date: Nov. 12, 2015

(54) Combination Guitar and Bass

(71) Applicants: David Graham, (US); Matthew Matessa, Evans City, PA (US); EurekaSound, LLC, Evans City, PA (US)

(72) Inventors: David Graham, Sewickley, PA (US); Matthew Matessa, Evans City, PA (US)

(73) Assignee: EUREKASOUND, LLC, Evans City, PA (US)

(21) Appl. No.: 14/272,654

(22) Filed: May 8, 2014

(51) Int. Cl. G10D 1/08; G10H 3/18

(52) U.S. Cl. CPC G10D 1/085; G10H 3/181

(57) ABSTRACT

This invention is a combination stringed musical instrument like a guitar along with bass guitar elements. The invention can be either acoustic or electric. The instrument employs a common body, neck, and fingerboard, with the scale of the neck and fingerboard of a traditional guitar. The instrument uses both standard guitar and standard bass guitar strings. Significantly, this invention is designed to incorporate one or more bass strings replacing string(s) of a traditional guitar, with those bass string(s) tuned one octave lower than the string(s) replaced. An arrangement of independent electromagnetic pickups is used to isolate the signals from the bass strings from the signals of the guitar strings, and optionally present those signals as combined or separate at the output jack.

### CROSS-REFERENCE TO RELATED APPLICATIONS

This application claims the benefit of U.S. Provisional Application No. 61/844,449, filed Jul. 10, 2013, the disclosure of which is incorporated herein by reference.

### BACKGROUND OF THE INVENTION

This invention relates to a musical instrument, more specifically a guitar combined with elements of a bass guitar in one device.

Several important music theory concepts play an important role in the invention. These are defined below:

Pitch Class. Pitch class is a set of all pitches that are a whole number of octaves apart. For example, the pitch class C consists of the Cs in all octaves. Thus, using scientific pitch notation (in which C₄, middle C, is 261.626 Hz), the pitch class “C” is the set

{Cₙ: n is an integer}={ . . . , C₋₂, C₋₁, C₀, C₁, C₂, C₃ . . . }

Scale length. Scale length is the maximum vibrating length of a strings to produce sound. For a guitar or other stringed instrument, that length is measured from the nut to the bridge of the instrument.

Guitar Tunings. Guitar tunings are the pitches assigned to the open strings of a guitar. Standard tuning of a guitar is defined in Table 1. Alternate tunings are variations of standard tuning, the most common categories being major, minor, modal, dropped, instrumental, and special

Guitars, both acoustic and electric, and bass guitars (hereafter referred to as “bass”) have been a mainstay in popular music since the early 1950's. The bass traditionally occupies a pitch range that is one octave lower than the guitar. The open string pitches and string characteristics of a traditional guitar and bass are shown in Table 1 and Table 2 below.

TABLE 1
Typical Guitar String Characteristics

| String | | Frequency | Diameter | Tension |
|---|---|---|---|---|
| Position | Note | (Hz) | (in) | (lbs) |
| 6 | E₂ | 82.407 | 0.046 | 17.5 |
| 5 | A₂ | 110.00 | 0.036 | 19.5 |
| 4 | D₃ | 146.83 | 0.026 | 18.4 |
| 3 | G₃ | 196.00 | 0.017 | 16.6 |
| 2 | B₃ | 246.94 | 0.013 | 15.4 |
| 1 | E₄ | 329.63 | 0.010 | 16.2 |

TABLE 2
Typical Bass String Characteristics

| String | | Frequency | Diameter | Tension |
|---|---|---|---|---|
| Position | Note | (Hz) | (in) | (lbs) |
| 5 | B₀ | 30.868 | 0.125 | 31.4 |
| 4 | E₁ | 41.203 | 0.095 | 34.4 |
| 3 | A₁ | 55.000 | 0.075 | 38.0 |
| 2 | D₂ | 73.416 | 0.060 | 42.9 |
| 1 | G₂ | 97.999 | 0.040 | 33.7 |

A common design element for both the guitar and bass is the pitch interval between open strings, which is four or five semitones. A variation of the traditional 6-string guitar, the 12-string guitar, has up to a 12-semitone open string pitch interval.

When musicians perform in a group, typically one or more musicians will play guitar while a different musician plays bass. It is often desirable, as in the case of a small group or a one man band, to have one musician play a combined instrument that covers the pitch range of both guitar and bass. There have been many attempts to combine a guitar with a bass into a single instrument. These attempts have consisted of instruments with multiple necks (such as the instruments defined in U.S. Pat. No. 1,183,369, or U.S. Pat. No. 6,649,818 B2), or an instrument that combines seven or more guitar and bass strings onto a single widened neck (such as instrument defined in U.S. Pat. No. 4,483,233 A, or U.S. Pat. No. 4,377,101). Significantly, all prior attempts to create a combined guitar and bass have either utilized multiple necks, seven or more strings, changed the traditional pitch class of a standard guitar, or a combination of these.

### BRIEF SUMMARY OF THE INVENTION

The invention is a musical instrument that preserves the basic elements, playability, and feel of a traditional guitar: a single neck, the number and placement of strings, the scale length, the fret size and spacing, the finger positioning and chord structure, and the open string pitch class. It differs from a typical guitar in two fundamental ways. First, one or more standard guitar strings are replaced with bass strings, providing the string or strings with a one octave drop in pitch of said string(s). Second, electromagnetic pickups are arranged in such a way as to isolate signals from individual or groups of strings. With this configuration, the isolated signals can not only be combined into a single output from the instrument—as with traditional guitars—but also into multiple signals that can be processed and/or amplified separately.

### BRIEF DESCRIPTION OF THE DRAWINGS

FIG. 1 shows a portion of the neck from a traditional 6-string guitar.

FIG. 2 shows a portion of the neck from a traditional 4-string bass.

FIG. 3 shows a portion of the neck from a traditional 5-string bass.

FIG. 4 shows a portion of the neck from a first variation of the novel instrument described in this patent with both guitar and bass strings on a single neck.

FIG. 5 shows a portion of the neck from a second variation of the novel instrument described in this patent with both guitar and bass strings on a single neck.

FIG. 6 shows a portion of the neck from a third variation of the novel instrument described in this patent with both guitar and bass strings on a single neck.

FIG. 7 shows the nut required for the second variation (FIG. 5).

FIG. 8 shows the full implementation of the second variation (FIG. 5).

### DETAILED DESCRIPTION OF THE INVENTION

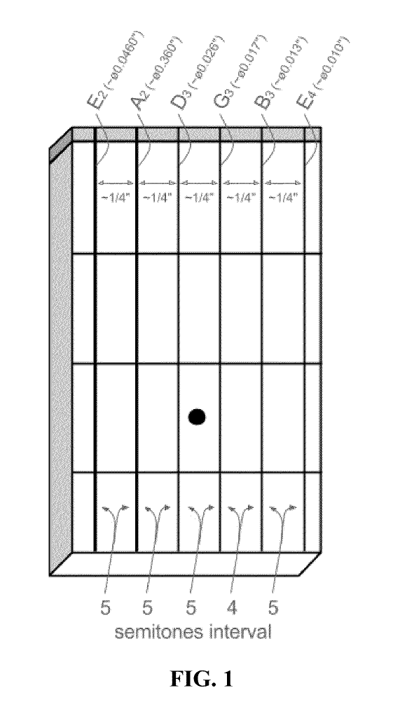

In order to create a musical instrument that will be immediately familiar to a traditional 6-string guitarist, it is important to maintain as many characteristics of the traditional guitar as possible, including similar neck and body dimensions, string scale length (24″ to 25.5″), and six strings with a standard or alternate guitar tuning. FIG. 1 shows a portion of the neck from such a traditional 6-string guitar, and the open string pitch, semitone interval between strings, approximate string diameter, and approximate string spacing (edge-to-edge) at the nut. These characteristics are summarized in Table 3.

TABLE 3
6 String Guitar Characteristics

| String | | Semitone | Diameter | Spacing |
|---|---|---|---|---|
| Position | Note | Interval | (in) | (in) |
| 6 | E | 5 | 0.042 | 0.25 |
| 5 | A | 5 | 0.036 | 0.25 |
| 4 | D | 5 | 0.026 | 0.25 |
| 3 | G | 5 | 0.017 | 0.25 |
| 2 | B | 4 | 0.013 | 0.25 |
| 1 | E | 5 | 0.010 | 0.25 |

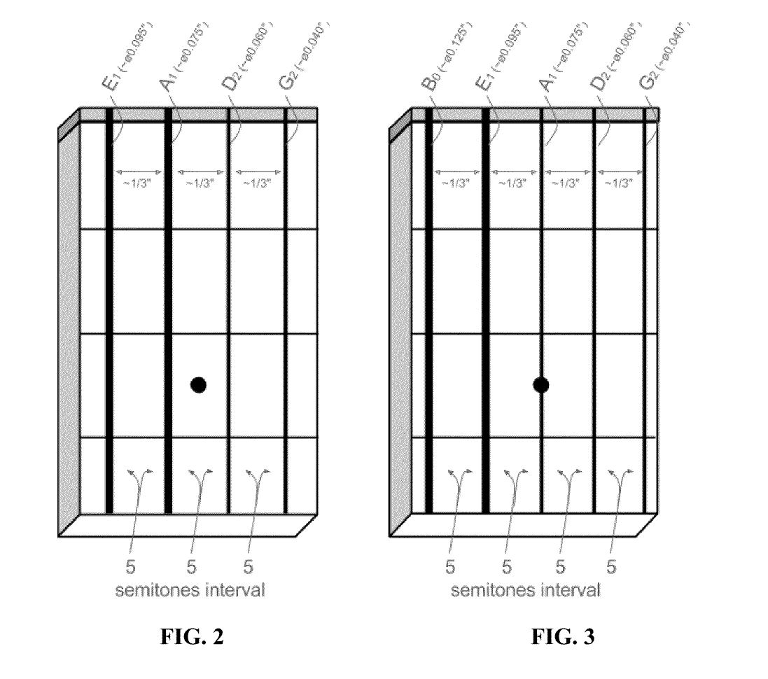

FIGS. 2 and 3 show a portion of the neck from a traditional 4-string and 5-string bass respectively, and the open string pitch, semitone interval between strings, approximate string diameter, and approximate string spacing (edge-to-edge) at the nut. These characteristics are summarized in Table 4 and Table 5.

TABLE 4
4 String Bass Characteristics

| String | | Semitone | Diameter | Spacing |
|---|---|---|---|---|
| Position | Note | Interval | (in) | (in) |
| 4 | E | 5 | 0.095 | 0.33 |
| 3 | A | 5 | 0.075 | 0.33 |
| 2 | D | 5 | 0.060 | 0.33 |
| 1 | G | 5 | 0.040 | 0.33 |

TABLE 5
5 String Bass Characteristics

| String | | Semitone | Diameter | Spacing |
|---|---|---|---|---|
| Position | Note | Interval | (in) | (in) |
| 5 | B | 4 | 0.125 | 0.33 |
| 4 | E | 5 | 0.095 | 0.33 |
| 3 | A | 5 | 0.075 | 0.33 |
| 2 | D | 5 | 0.060 | 0.33 |
| 1 | G | 5 | 0.040 | 0.33 |

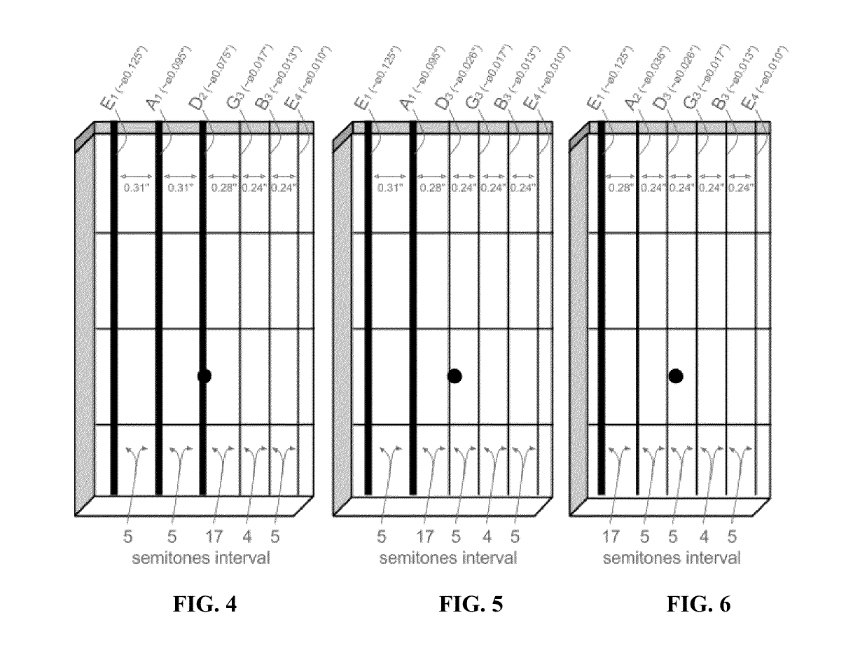

In order to introduce pitches from the bass range onto a 6-string guitar, one or more guitar strings are replaced with bass strings. FIGS. 4-6 detail three possible variations of this concept. There are several important details in FIGS. 4-6. First, notice that the open string pitch in this example is the same for each variation, E, A, D, G, B, E. Second, notice that the semitone interval is the same as a standard guitar except for one interval in each variation that is 17 semitones; 17 semitones is one octave greater than the standard 5 semitone interval, thus maintaining the traditional pitch class open string tuning. For Variation 1 (FIG. 4) the 17 semitone interval occurs between D₂ and G₃. For Variation 2 (FIG. 5) the 17 semitone interval occurs between A₁ and D₃. For Variation 3 (FIG. 6) the 17 semitone interval occurs between E₁ and A₂.

Another important detail in FIGS. 4-6 is the diameter of the bass strings. Note that the lowest pitch string has a diameter of 0.125″ and a pitch of E₁. The 0.125″ diameter string is present in FIG. 3 on the 5-string bass, but with a pitch of B₀. The difference in pitch is due to the scale length difference between a guitar and bass. The scale length of a traditional guitar ranges from 24″ to 25.5″, while the scale length of a bass guitar is most commonly 34″. On a 5-string bass with a 34″ scale, the fifth string has a diameter of 0.125″ and an open pitch of B₀. On such an instrument, a player could produce an E₁ by pressing the 5th fret from the nut. That distance is approximately 25.5″, the scale length of a traditional 6-string guitar. By using the thicker bass string of 0.125″, this invention can provide an E₁ open pitch on the sixth string—one octave lower than the sixth string on a traditional guitar.

Lastly, the string spacing illustrated in FIGS. 4-6 represents traditional guitar string spacing between guitar strings, slightly less than traditional bass string spacing between bass strings, and a spacing between the adjacent guitar and bass string that is halfway between guitar and bass string spacing.

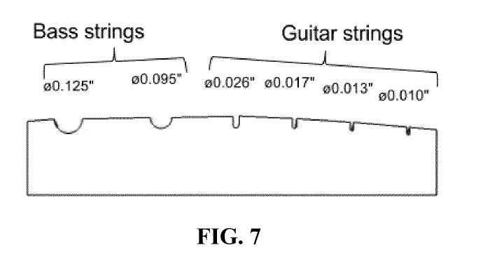

FIG. 7 shows the design of the nut required to accommodate two bass strings and four guitar strings (Variation #2, FIG. 5). Note the difference in string diameter slots for bass strings versus guitar strings.

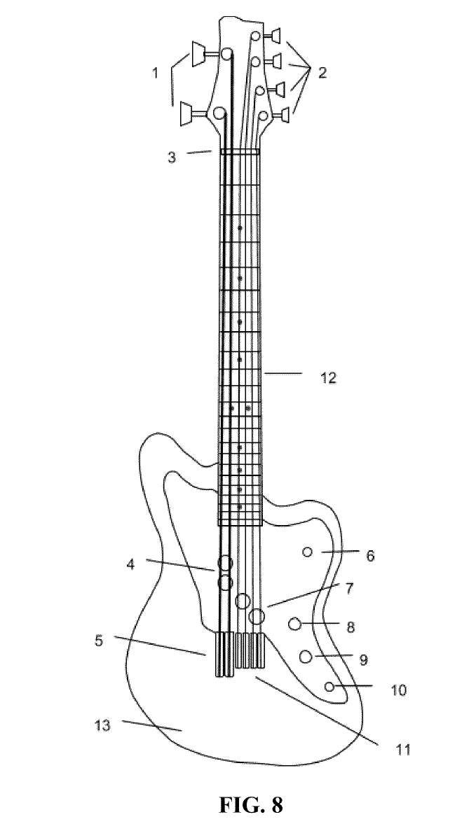

FIG. 8 illustrates a full implementation of this invention, specifically an electric variation of this invention with two bass strings and four guitar strings, with open string tuning of (E₁, A₁, D₃, G₃, B₃, E₄). Many accommodations are required for the bass strings, specifically with regard to the nut, the bridge, pickup placement, and tuning machines.

In FIG. 8, tuning machines 1 and single string bridges 5 are used for the bass strings. Tuning machines 2 and single string bridges 11 are used for the guitar strings. Nut 3 supports the two bass and four guitar strings, like the example nut pictured in FIG. 7. The neck 12 is a traditionally sized guitar neck, with a nut and fretboard that are wide enough to accommodate the spacing shown in Variation #2 (FIG. 5). The guitar body 13 is a standard sized guitar body. Electromagnetic pickups 4 are positioned to capture energy from the two bass strings while rejecting energy from the adjacent guitar strings. Electromagnetic pickups 11 are positioned to capture energy only from the four guitar strings. Concentric potentiometer 8 is used to adjust tone and volume for electromagnetic pickups 4. Concentric potentiometer 9 is used to adjust tone and volume for electromagnetic pickups 7. Switch 6 is used to either direct signals from both electromagnetic pickups 4 & 7 to the center tip of jack 10, or to direct electromagnetic pickup 7 to the tip of jack 10 and electromagnetic pickup 4 to the ring of jack 10. Separating the signals from the bass electromagnetic pickups and guitar electromagnetic pickups allow these signals to be used in completely different effect and amplification chains.

FIG. 8 is but one instantiation of this invention, with other variations not discussed in this section.

What is claimed is:

1. A guitar of the type employing a body, a neck, and a plurality of strings, the improvement comprising: said plurality of strings comprising six strings tuned in ascending order from a bass note to a treble note, with the open string tuning being of either standard or alternative type, with one or more strings being a bass string tuned one octave lower than the corresponding guitar string, whereby a guitarist can play said six mixed bass and guitar strings in the manner of a conventional six stringed guitar.

2. The guitar of claim 1 wherein string position 6 is a bass string and string position 5-1 are guitar strings.

3. The guitar of claim 1 wherein string positions 6 and 5 are bass strings and string positions 4-1 are guitar strings.

4. The guitar of claim 1 wherein string positions 6-4 are bass strings and string positions 3-1 are guitar strings.

5. The guitar of either claim 1, claim 2, claim 3, or claim 4 wherein said six strings are spaced in the playing region, whereby said guitarist may play the guitar by normal fingering.

6. A string, electromagnetic pickup, switch, and output jack arrangement in which a single or plurality of strings engage a single or plurality of electromagnetic pickups and a separate single or plurality of strings engage a separate singular or plurality of electromagnetic pickups, and a switch is used to either route the separate signals from these separate groups to different output connections, or combine the signals from these separate groups to a single output connection.

7. The electromagnetic pickup, switch, and output jack arrangement in claim 6 where there is one group consisting of a single string and single electromagnetic pickup, and another group consisting of five strings and two electromagnetic pickups.

8. The electromagnetic pickup, switch, and output jack arrangement in claim 6 where there is one group consisting of a single string and two electromagnetic pickups, and another group consisting of five strings and two electromagnetic pickups.

9. The electromagnetic pickup, switch, and output jack arrangement in claim 6 where there is one group consisting of two strings and single electromagnetic pickup, and another group consisting of four strings and two electromagnetic pickups.

10. The electromagnetic pickup, switch, and output jack arrangement in claim 6 where there is one group consisting of two strings and two electromagnetic pickups, and another group consisting of four strings and two electromagnetic pickups.

11. The electromagnetic pickup, switch, and output jack arrangement in claim 6 where there is one group consisting of three strings and two electromagnetic pickups, and another group consisting of three strings and two electromagnetic pickups.
